(19) United States
(12) Patent Application Publication
(10) Pub. No.: US 2009/0303070 A1
(43) Pub. Date: Dec. 10, 2009

(54) Distributed Decision Making Area Earthquake Warning System

(76) Inventors: Jie Zhang, San Jose, CA (US); Yu Han, San Jose, CA (US); Fang Tian, Palo Alto, CA (US)

Correspondence Address: Jie Zhang, 1806 Libretto Ct, San Jose, CA, 95131, US

(21) Appl. No.: 12/136,289

(22) Filed: Jun. 10, 2008

(51) Int. Cl. G08B 21/00

(52) U.S. Cl. 340/690

(57) ABSTRACT

An improved area earthquake warning system based on distributed decision making method, which makes such a system affordable in the region where wired and wireless mobile communication infrastructures are too expensive to build. The present invention can provide seconds, even tens of seconds for users to seek shelter to reduce injuries and lives lost. An exemplary embodiment of the invention described herein comprises a network of earthquake detection sites covering a geographic region with four types of earthquake detection sites. Instead of sending all raw ground motion signals to a remote central processing site, these detection sites send processed earthquake parameters to a nearby alarm site to decide if an earthquake alarm broadcasting should be triggered. This method shortens the response time, decreases the false alarm rate, and provides unlimited scalability. Further more, this invention provides self-check mechanism to eliminate system malfunction time.

### FIELD OF INVENTION

Present invention relates to an earthquake warning system. As well known, it is extremely difficult to rationally forecast a short or medium term earthquake. However, since electromagnetic wave's propagation speed (about 300K km/s) is much faster than destructive seismic waves (about 3 km/s), theoretically it's possible to build an earthquake warning system, by continuously monitoring and detecting earthquake occurrence near epicenter in real time and accurately determining earthquake parameters, to provide seconds, even tens of seconds warning window to epicenter periphery area. This invention provides an affordable area earthquake warning system based on distributed decision making method. An exemplary embodiment of the invention described herein comprises a network of earthquake detection sites covering a geographic region with four types of earthquake detection sites. Instead of sending all raw ground motion signals to a remote central processing site, these detection sites send processed earthquake parameters to a nearby alarm site to decide if an earthquake alarm broadcasting should be triggered. This method shortens the response time, decreases the false alarm rate, and provides unlimited scalability. Further more, this invention provides self-check mechanism to eliminate system malfunction time.

### PRIOR ART

Conventional earthquake warning systems use a front end earthquake sensor to collect raw signals, then sends raw data back to central processing unit through network for centralized analysis; after making any conclusion, it dispatches an alarm back to relevant areas through network. This kind of system requires huge data transfer and high computation power, so it can't meet the low cost and real time expectations.

Modern earthquake warning systems use smart front end earthquake detection equipment which can handle raw signal processing. Typical smart front end devices can estimate earthquake magnitude and location to trigger an alarm within a few seconds of initial P wave; or estimate the expected destructiveness immediately from the earthquake motion directly; also some low cost portable seismometer can issue alarm with the trigger of both acceleration and intensity. All these technologies detect earthquake at the front end, then provide preliminary results to central management system for final decision through wired network or non-relay wireless network communication. Non-relay wireless technologies may be affordable to support real time communication up to 30 km range. System cost will drastically increase as coverage range expands. Short wave is cheap and support no-relay wireless communication which is within 30 km (by ground wave) or over 100 km (by sky wave) range, leaves 30˜100 km range as “blind spot”; Satellite can cover wireless communication of any range, but too expensive; Mobile network also can support wireless communication of any range as far as cell base station is available nearby, plus it may take up to minutes to get communication channel granted, especially during heavy call volume period.

All in all, technologies discussed above are insufficient to build an affordable earthquake warning system in the region where wired and wireless mobile communication infrastructures are too expensive to build.

[Patent Reference 1] U.S. Pat. No. 5,910,763

[Patent Reference 2] US 2007/0033153 A1

[Patent Reference 3] US 2007/0144242 A1

[Patent Reference 4] US 2008/0111705 A1

### SUMMARY OF THE INVENTION

An aspect of the present invention is to substantially address all of the above problems and/or disadvantages. Accordingly, this invention is to provide an improved area earthquake warning system based on distributed decision making method built on top of relay mode wireless communication. Its self-check mechanism can eliminate system malfunction time. This invention can provide seconds, even tens of seconds early warning window. The system overview is shown in FIG. 1. Such an area earthquake warning system can be affordable in the region where wired and wireless mobile communication infrastructures are too expensive to build.

According to one aspect of the present invention, four types of earthquake detection sites are provided, as shown in FIG. 2: Level I Site, which is an earthquake detection site, consists of multiple types of earthquake detection sensors, signal processing device and wireless transmitter, powered by solar cell and re-chargeable battery, as shown in FIG. 3; Level II Site, which includes a Level I Site plus a wireless signal relay device, powered by solar cell and re-chargeable battery, as shown in FIG. 4; Level III Site, which includes a Level II Site plus a wireless broadcasting device, has the capability of issuing and broadcasting an earthquake alarm signal, powered by UPS type power supply, as shown in FIG. 5; Level IV Site which includes a Level III Site plus area network management system, powered by UPS type power supply, as shown in FIG. 6.

According to one aspect of the present invention, five classes of system signals are provided, as shown in FIG. 7: Class A site status signal; Class B minor earthquake signal; Class C1 internal earthquake alarm signal; Class C2 broadcasting earthquake alarm signal; and Class D client test signal.

According to one aspect of the present invention, two types of regions are provided, as shown in FIG. 8: Monitor region, which is the sum of all the areas around earthquake detection site (Level I˜IV); Warning region, which is the sum of all the areas covered by broadcasting signal of Level III˜IV sites.

According to one aspect of the present invention, two types of client terminals are provided, as shown in FIG. 2: Mobile client terminal is an alarm terminal designed for mobile clients, which may have a positioning system like GPS (Global Position System), and consists of a wireless signal receiver, a decoder for earthquake alarm signal (class C2) and client test signal (Class D), and an alarm device; Fixed client terminal is an alarm terminal designed for non-mobile clients, which should know and always remember its position, and consists of a wireless signal receiver, a decoder for earthquake alarm signal (class C2) and client test signal (Class D), and an alarm device.

According to one aspect of the present invention, each Level III and Level IV site has the decision making capability to issue and broadcast an earthquake alarm signal (Class C2) based on the received internal earthquake alarm signals (Class C1) and minor earthquake signals (Class B).

According to one aspect of the present invention, multiple data links based on wireless relay communication and short pulse message burst mode are provided. (1) A site status reporting data link, which handles Class A signal, is active routinely for sites health check, as shown in FIG. 9; (2) A minor earthquake reporting data link, which handles Class B signal, is active when a minor earthquake is detected, as shown in FIG. 10; (3) An earthquake alarming data link, which handles Class C1 and C2 signal, is active when a strong earthquake is detected, as shown in FIG. 11; (4) A client terminal testing data link, which handles Class D signal, is active routinely for the health check of client terminals, as shown in FIG. 12.

According to one aspect of the present invention, any two sites communicate with each other through one or more sites with relaying capability if the distance is beyond their ability of direct communication.

According to one aspect of the present invention, a redundant method is used in both the signal format and the frequency channels of wireless communication to increase the reliability of said data links.

According to one aspect of the present invention, an encryption method is used in signal coding to protect said data links from signal forgery.

According to one aspect of the present invention, a self-check mechanism is provided: (1) Each Level IV site inspects the status signals (Class A) from all the sites in said monitoring region. A maintenance request will be issued to system operator if any site does not report its status correctly; (2) Each Level III˜IV site issues client test signal (Class D) routinely. Every client terminal checks its health by verifying whether it can receive such signal correctly both in timing and content, and notify user; (3) Each Level IV site inspects the earthquake signals (Class B and Class C1) from all the sites in said monitoring region. A maintenance request will be issued to system operator if any site does not respond to a known earthquake properly in its monitoring region.

### BRIEF DESCRIPTION OF THE DRAWINGS

The above and other aspects, features and advantages of the present invention will become more apparent from the following detailed description of certain exemplary embodiments taken in conjunction with the accompanying drawing in which:

FIG. 1 is a diagram illustrating the overview of distributed decision making area earthquake warning system according to an exemplary embodiment of the present invention.

FIG. 2 is a diagram illustrating the four types of earthquake detection sites and two types of client terminals according to an exemplary embodiment of the present invention.

FIG. 3 is a block diagram illustrating Level I site according to an exemplary embodiment of the present invention.

FIG. 4 is a block diagram illustrating Level II site according to an exemplary embodiment of the present invention.

FIG. 5 is a block diagram illustrating Level III site according to an exemplary embodiment of the present invention.

FIG. 6 is a block diagram illustrating Level IV site according to an exemplary embodiment of the present invention.

FIG. 7 is a diagram illustrating the five classes of system signals according to an exemplary embodiment of the present invention.

FIG. 8 is a diagram illustrating the two types of regions according to an exemplary embodiment of the present invention.

FIG. 9 is a flowchart illustrating the site status reporting (Class A) data link according to an exemplary embodiment of the present invention.

FIG. 10 is a flowchart illustrating the minor earthquake reporting (Class B) data link according to an exemplary embodiment of the present invention.

FIG. 11 is a flowchart illustrating the earthquake alarming (Class C1 and Class C2) data link according to an exemplary embodiment of the present invention.

FIG. 12 is a flowchart illustrating the client terminal testing (Class D) data link according to an exemplary embodiment of the present invention.

### DETAILED DESCRIPTION OF THE INVENTION

Following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

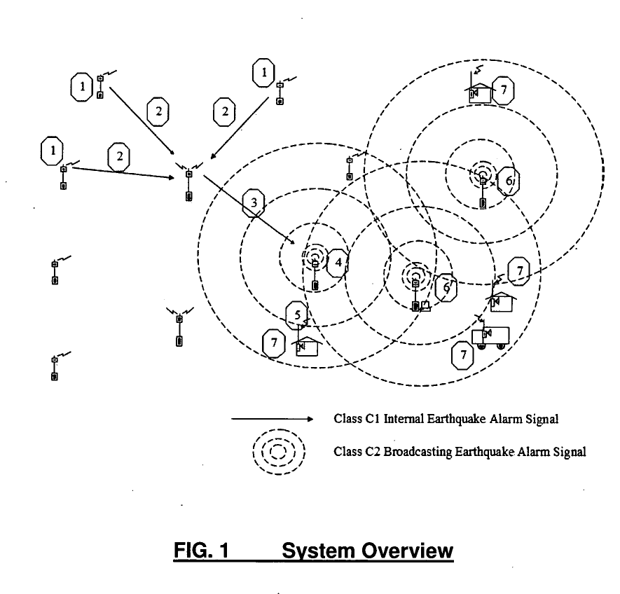

Referring to FIG. 1, present invention implements an affordable area earthquake warning system based on distributed decision making method. This invention comprises a network of earthquake detection sites covering a geographic region with four types of earthquake detection sites. Instead of sending all raw ground motion signals to a remote central processing site, these detection sites send processed earthquake parameters to a nearby distributed decision site to decide if an earthquake alarm broadcasting should be triggered. Each distributed decision site broadcasts earthquake alarm to cover its alarm service area.

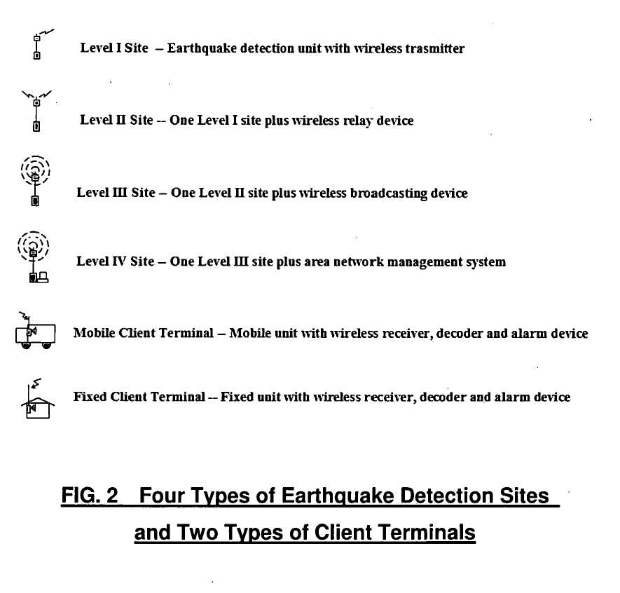

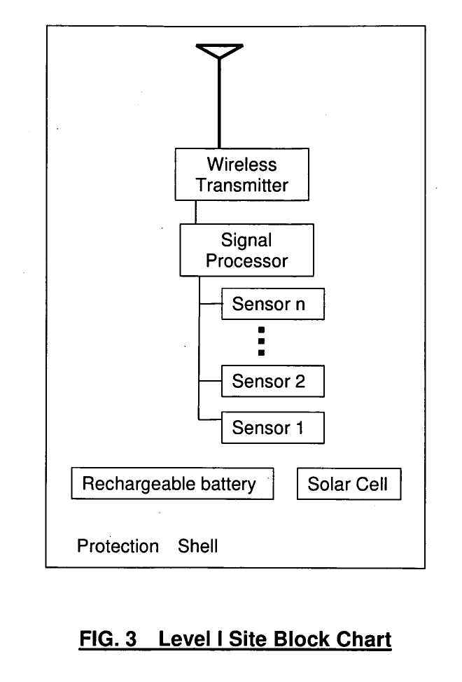

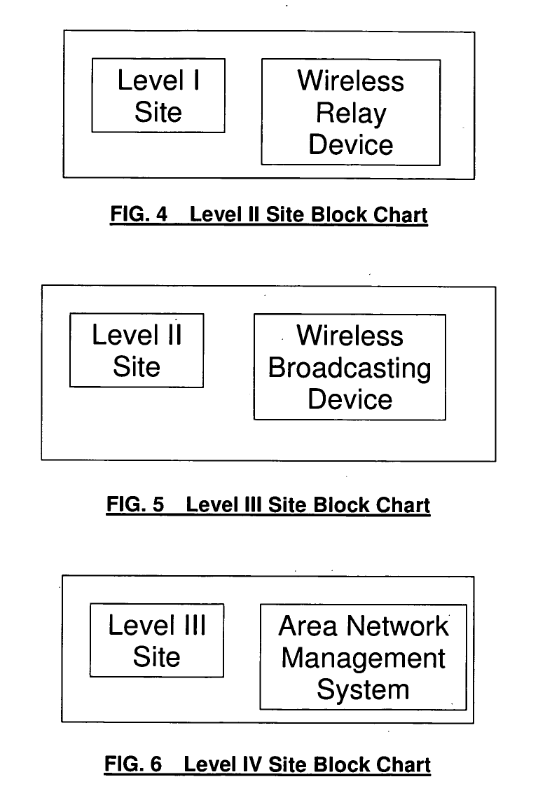

Referring to FIG. 2, present invention defines five types of earthquake detection sites: Level I Site, which is an earthquake detection site, consists of multiple types of earthquake detection sensors, signal processing device and wireless transmitter, powered by solar cell and re-chargeable battery, as shown in FIG. 3; Level II Site, which includes a Level I Site plus a wireless signal relay device, consists of multiple types of earthquake detection sensors, signal processing device, multiple channels wireless receiver, and wireless transmitter, powered by solar cell and rechargeable battery, as shown in FIG. 4; Level III Site, which includes a Level II Site plus an wireless broadcasting device, consists of multiple types of earthquake detection sensors, signal processing device, multiple channels wireless receiver, wireless transmitter and wired communication alarm interface, powered by UPS type power supply, has the capability of issuing and broadcasting an earthquake alarm signal, as shown in FIG. 5; Level IV Site, which includes a Level III Site plus area network management system, powered by UPS type power supply, as shown in FIG. 6.

Preferably, since the functionalities modules from Level I to IV sites are appended level by level, similar module technologies can be reused across levels to reduce overall manufacture, testing and maintenance cost.

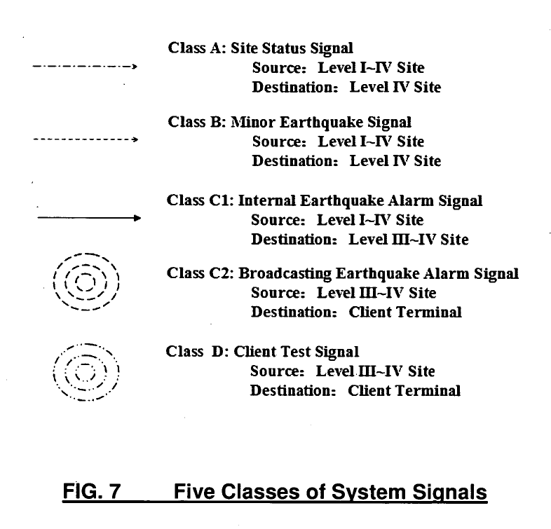

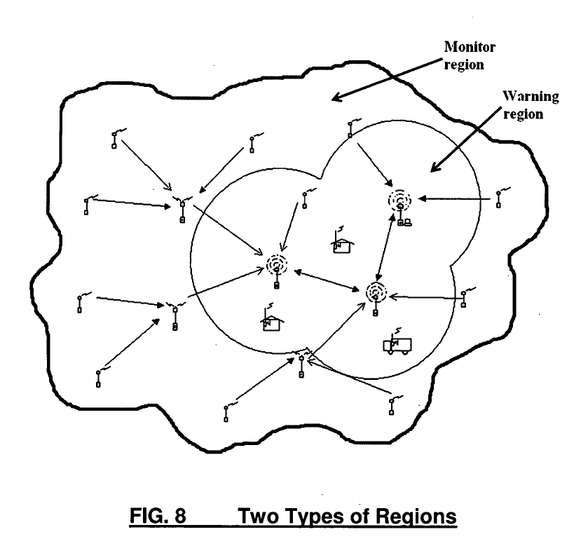

Referring to FIG. 7, present invention defines five classes of system signals: Class A site status signal; Class B minor earthquake signal; Class C1 internal earthquake alarm signal; Class C2 broadcasting earthquake alarm signal; and Class D client test signal.

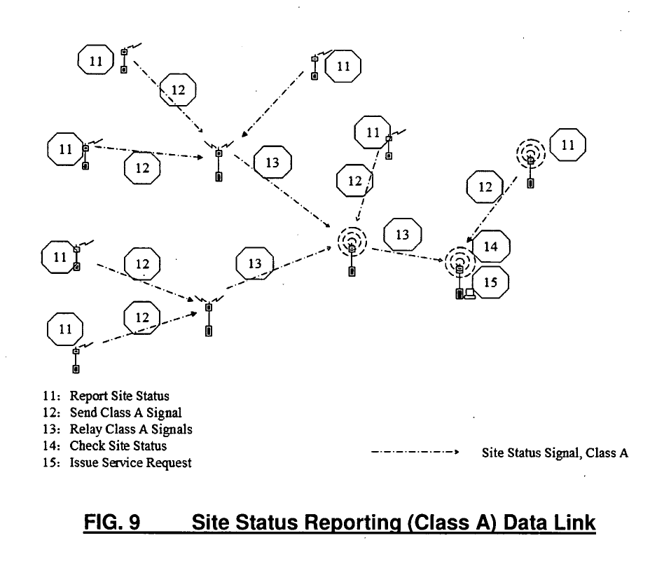

Referring to FIG. 8, present invention defines two types of regions: Monitor region, which is the sum of all the areas around earthquake detection site (Level I˜IV); Warning region, which is the sum of all the areas covered by broadcasting signal of Level III˜IV sites.

Referring to FIG. 2, present invention defines two types of client terminals: Mobile client terminal is an alarm terminal designed for mobile clients, which may have a positioning system like GPS (Global Position System), and consists of a wireless signal receiver, a decoder for earthquake alarm signal (class C2) and client test signal (Class D), and an alarm device; Fixed client terminal is an alarm terminal designed for non-mobile clients, which should know and always remember its position, and consists of a wireless signal receiver, a decoder for earthquake alarm signal (class C2) and client test signal (Class D), and an alarm device.

According to such a system, each Level III and Level IV site has the decision making capability to issue and broadcast an earthquake alarm signal (Class C2) based on the received internal earthquake alarm signals (Class C1) and minor earthquake signals (Class B).

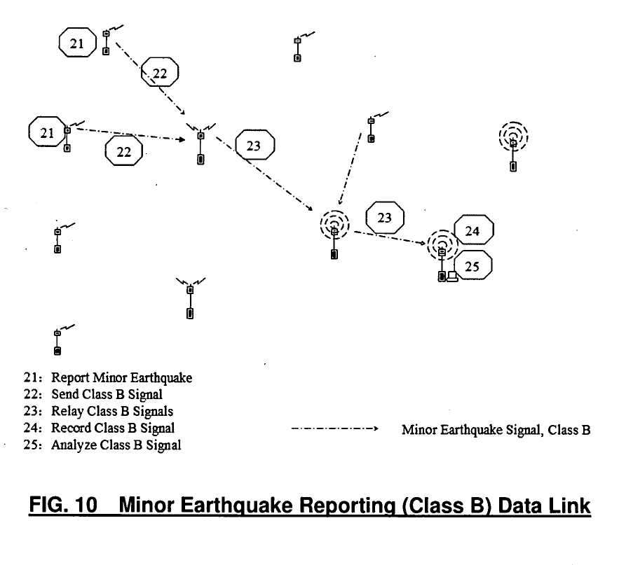

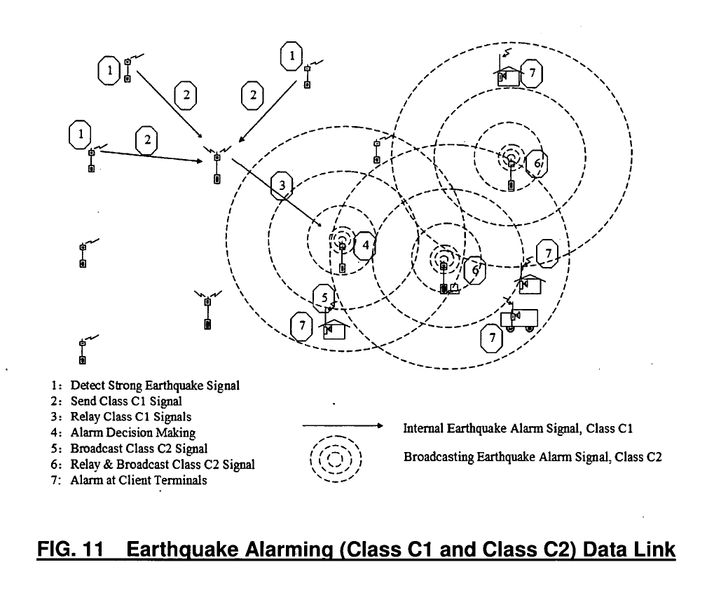

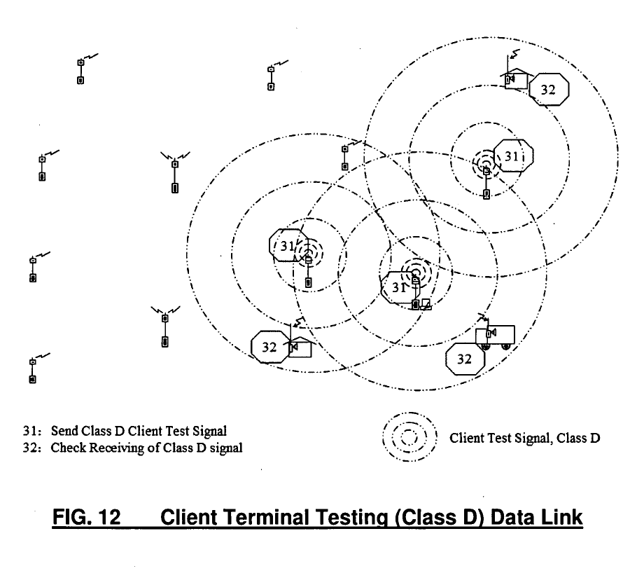

Present invention defines multiple data links based on wireless relay communication and short pulse message burst mode. (1) A site status reporting data link, which handles Class A signal, is active routinely for sites health check, as shown in FIG. 9; (2) A minor earthquake reporting data link, which handles Class B signal, is active when a minor earthquake is detected, as shown in FIG. 10; (3) An earthquake alarming data link, which handles Class C1 and C2 signal, is active when a strong earthquake is detected, as shown in FIG. 11; (4) A client terminal testing data link, which handles Class D signal, is active routinely for the health check of client terminals, as shown in FIG. 12.

According to such a system, any two sites communicate with each other through one or more sites with relaying capability if the distance is beyond their ability of direct communication.

According to such a system, a redundant method is used in both the signal format and the frequency channels of wireless communication to increase the reliability of said data links.

According to such a system, an encryption method is used in signal coding to protect said data links from signal forgery.

Present invention provides self-check mechanism: (1) Each Level IV site inspects the status signals (Class A) from all the sites in said monitoring region. A maintenance request will be issued to system operator if any site does not report its status correctly; (2) Each Level III˜IV site issues client test signal (Class D) routinely. Every client terminal checks its health by verifying whether it can receive such signal correctly both in timing and content, and notify user; (3) Each Level IV site inspects the earthquake signals (Class B and Class C1) from all the sites in said monitoring region. A maintenance request will be issued to system operator if any site does not respond to a known earthquake properly in its monitoring region.

Referring to FIG. 3, Level I site captures local earthquake intensity signal in real time, use redundant sensor arrays to improve earthquake detection accuracy and reliability. When detects earthquake signals above pre-determined threshold, it sends Class C1 internal earthquake alarm signal immediately; otherwise, it just sends Class B minor earthquake signal. Level I site uses minor earthquake signal to execute self diagnostic and generate Class A site status signal. When there's no earthquake occurrence, at specific long intervals Level I site sends Class A status signal, at other time the site keeps “silent” to avoid unnecessary communication bandwidth consumption

Present invention selects some Level I sites and upgrades them to be Level II sites to provide relay mode wireless communication. The selection criteria are: (1) At least one Level II˜IV sites should be available within any Level I site's covering area; (2) At least another Level II˜IV sites should be available within any Level II site's covering area.

Referring to FIG. 4, Level II site implements all Level I site functionalities, plus it should correctly relay Class A, B, C1 and C2 signals to guarantee fluent real time communication, meanwhile it should avoid relay duplicated signals to save bandwidth.

Present invention selects some Level II sites and upgrades them to be Level III sites to cover warning region. The selection criteria are: (1) Any client terminal should be within at least one Level III˜IV site broadcasting signal covering area; (2) At least another Level II˜IV site should be available within any Level III site's covering area for signal relay.

Referring to FIG. 5, Level III site implements all Level I site functionalities, plus processes Class A, B and C1 signals (including signals generated by itself). (1) When Level III site receives Class B minor earthquake signal and Class C1 internal earthquake alarm signal, it uses decision making algorithms to conclude earthquake parameters (intensity, location and rupture time) and determine whether issue Class C2 broadcasting earthquake alarm signal. (2) Level III site relays Class A/B signals to Level IV site. But if this level III site is in the middle of processing Class C1 signal, Class A/B signal relay should be deferred. (3) When there's no earthquake occurrence, Level III site broadcasts Class D test signal to client terminals at specific long intervals. (4) Since level III site is responsible for earthquake alarm signal broadcasting, the wireless transmitter works at much higher power than level loll sites, plus it may also provides wired communication alarm interface.

To guarantee reliable and stable system operation, present invention selects two Level III sites and upgrades them to be Level IV sites. One is on duty; the other is for back-up.

Referring to FIG. 6, Level IV site implements all Level III site functionalities, plus (1) Receive Class A site status signal, check relevant site's integrity, informs maintenance staff to handle abnormal or lost sites; (2) Receive and inspect the earthquake signals (Class B and Class C1) from all the sites in said monitoring region. A maintenance request will be issued to system operator if any site does not respond to a known earthquake properly in its monitoring region; and (3) Record all received Class A, B, C1, C2 signals into database for future research.

If client terminal receives class C2 broadcast earthquake alarm signal, it extracts earthquake parameters (intensity, location and rupture time), according to its own position, determines the earthquake arrival time, alarm level and activate alarm. Client terminal may be integrated with existing hazard alarm devices, e.g., fire alarm devices. Also client terminal verifies its own integrity based on whether it can receive stable Class D test signal, both in timing and content; client terminal displays the result status on user interface to inform operator whether this client terminal need repair.

Referring to FIG. 9 for typical site status reporting data link signal flow: (Label 11) Level I˜IV site executes self diagnostic to generate site status report; (Label 12) At specific long intervals the site sends out class A status report signal; (Label 13) This class A status signal may be relayed by one or multiple level II˜III sites if needed; (Label 14) Finally this class A status signal arrives Level IV site, which should analyze the signal to check source site's status; (Label 15) The Level IV site may issue service request if source site is abnormal or “lost”.

Referring to FIG. 10 for typical minor earthquake reporting data link signal flow: (Label 21) Level I˜IV site captures local earthquake intensity signal in real time. When detecting earthquake signals below pre-determined threshold, it generates Class B minor earthquake signal; (Label 22) The site sends Class B minor earthquake signal immediately; (Label 23) This class B signal may be relayed by one or multiple level II˜III sites if needed; (Label 24) Finally this class B signal arrives Level IV site, which should record this signal into database; (Label 25) Level IV site may analyze Class B signals in the future.

Referring to FIG. 11 for typical earthquake alarming data link signal flow: (Label 1) Level I˜IV site captures local earthquake intensity signal in real time. When detecting earthquake signals above pre-determined threshold, it generates Class C1 internal earthquake alarm signal; (Label 2) The site sends Class C1 internal earthquake alarm signal immediately; (Label 3) This Class C1 signal may be relayed by one or multiple level II sites if needed; (Label 4) When Level III site receives Class C1 signal, it concludes earthquake parameters (intensity, location and rupture time), then uses decision making algorithms based on all received Class C1 and Class B signals to determine whether issue Class C2 broadcasting earthquake alarm signal; (Label 5) The Level III site broadcasts Class C2 signal; (Label 6) The Class C2 signal may be relayed by one or multiple level II˜IV sites if needed. Any level III˜IV sites involved in the Class C2 signal propagation path should broadcast earthquake alarm to inform any client terminal within its alarming service area; (Label 7) Client terminal receives Class C2 signal, it extracts earthquake parameters (intensity, location and rupture time), according to its own position, determines the earthquake arrival time, alarm level and activate alarm.

Referring to FIG. 12 for typical client testing data link signal flow: (Label 31) When there's no earthquake occurrence, Level III site broadcasts Class D client test signal to client terminals at specific long intervals; (Label 32) Client terminal verifies its own integrity based on whether it can receive stable Class D signal, both in timing and content; client terminal displays the result status on user interface to inform operator whether this client terminal need repair.

As described above, according to exemplary embodiments of the present invention, based on distributed decision making method, an improved area earthquake warning system can be affordable in the region where wired and wireless mobile communication infrastructures are too expensive to build to provide seconds, even tens of seconds for users to seek shelter to reduce injuries and lives lost.

While the invention has been shown and described with reference to certain exemplary embodiments thereof, it will be understood by those skilled in the art that various changes in form and details may be made therein without departing from the spirit and scope of the invention defined by the appended claims and their equivalents.

What is claimed is:

1. An area earthquake warning system based on distributed decision making method. It comprises a network of earthquake detection sites covering a geographic region with four types of earthquake detection sites:
Level I Site: An earthquake detection site, which consists of multiple types of earthquake detection sensors, signal processing device and wireless transmitter, powered by solar cell and re-chargeable battery.
Level II Site: Level I Site plus a wireless signal relay device, powered by solar cell and re-chargeable battery.
Level III Site: Level II Site plus a wireless broadcasting device. It has the capability of issuing and broadcasting an earthquake alarm signal, powered by UPS type power supply.
Level IV Site: Level III Site plus area network management system, powered by UPS type power supply.

2. The area earthquake warning system of claim 1 further comprising five types of system signals:
Class A: Site status signal.
Class B: Minor earthquake signal.
Class C1: Internal earthquake alarm signal.
Class C2: Broadcast earthquake alarm signal.
Class D: Client test signal.

3. The area earthquake warning system of claim 1 further comprising two types of regions:
Monitor region: The sum of all the areas around earthquake detection site (Level I˜IV).
Warning region: The sum of all the areas covered by broadcasting signal of Level III˜IV sites.

4. The area earthquake warning system of claim 1 further comprising two types of client terminals:
Mobile Client Terminal: An alarm terminal designed for mobile clients, which consists of a wireless signal receiver, a decoder for earthquake alarm signal (class C2) and client test signal (Class D), and an alarm device.
Fix Client Terminal: An alarm terminal designed for non-mobile clients, which consists of a wireless signal receiver, a decoder for earthquake alarm signal (class C2) and client test signal (Class D), and an alarm device.

5. The area earthquake warning system of claim 1, wherein each Level III and Level IV site has the decision making capability to issue and broadcast an earthquake alarm signal (Class C2) based on the received internal earthquake alarm signals (Class C1) and minor earthquake signals (Class B).

6. The area earthquake warning system of claim 1 further comprising multiple data links based on wireless relay communication and short pulse message burst mode. Said data links include:
An earthquake alarming data link, which handles Class C1 and C2 signal and is active when a strong earthquake is detected.
A minor earthquake reporting data link, which handles Class B signal and is active when a minor earthquake is detected.
A site status reporting data link, which handles Class A signal and is active routinely for sites health check.
A client terminal testing data link, which handles Class D signal and is active routinely for the health check of client terminals.

7. The multiple data links of claim 6, wherein any two sites communicate with each other through one or more sites with relaying capability if the distance is beyond their ability of direct communication.

8. The multiple data links of claim 6, wherein a redundant method is used in both the signal format and the frequency channels of wireless communication to increase the reliability of said data links.

9. The multiple data links of claim 6, wherein an encryption method is used in signal coding to protect said data links from signal forgery.

10. The area earthquake warning system of claim 1 further comprising a self-check mechanism.

11. The self-check mechanism of claim 10, wherein each Level IV site inspects the status signals (Class A) from all the sites in said monitoring region. A maintenance request will be issued to system operator if any site does not report its status correctly.

12. The self-check mechanism of claim 10, wherein each Level III˜IV site issues client test signal (Class D) routinely. Every client terminal checks its health by verifying whether it can receive such signal correctly both in timing and content, and notify user.

13. The self-check mechanism of claim 10, wherein each Level IV site inspects the earthquake signals (Class B and C1) from all the sites in said monitoring region. A maintenance request will be issued to system operator if any site does not respond to a known earthquake properly in its monitoring region.
